(19) United States
(12) Patent Application Publication
(10) Pub. No.: US 2010/0084919 A1
(43) Pub. Date: Apr. 8, 2010

(54) REPLACEMENT SYSTEM OF DISTRIBUTION TRANSFORMERS AND LOW-VOLTAGE POWER LINE WITHOUT OUTAGE

(75) Inventor: Dong-Yeol SHIN, Daejeon (KR)

Correspondence Address: LRK Patent Law Firm, 1952 Gallows Rd, Suite 200, Vienna, VA, 22182, US

(73) Assignee: KOREA ELECTRIC POWER CORPORATION, Daejeon (KR)

(21) Appl. No.: 12/257,328

(22) Filed: Oct. 23, 2008

(30) Foreign Application Priority Data
Jun. 9, 2008 (KR) 10-2008-0053716

(51) Int. Cl. H02J 9/00

(52) U.S. Cl. 307/64

(57) ABSTRACT

Disclosed herein is a replacement system of a distribution transformer and a low-voltage power line without outage. A distribution-line uninterruptible power supply includes a transformer primary bypass cable, a transformer secondary bypass cable, and a low-voltage power line bypass cable. Further, the uninterruptible power supply includes a combined phase-shifter and three-phase transformer, a transformer primary bypass switch, a transformer secondary bypass switch, a phase-based power adjuster, an energy converter, and a three-phase AC/DC converter. The capacity of the target transformer can be extended to one and half times that of the existing transformer. The energy conversion process of this system allows the utilization ratio of the transformer to be adjusted according to the phases, and has an advantage of extending the replaceable range at a low voltage without outage. Practical equipment can be secured at a low cost by replacing only the transformer in the existing uninterruptible power supply.

### BACKGROUND OF THE INVENTION

1. Field of the Invention

The present invention relates to a replacement system that replaces a distribution transformer installed on a 22.9 KV distribution-line without outage, which can be given to a customer at a secondary side of the transformer, when replacing the transformer due to overload, new extension, deterioration, etc. thereof. The system includes a combined phase-shifter and three-phase-transformer structure obtained by combining the existing mobile transformer and a phase shifter, and an energy conversion unit capable of adjusting a utilization ratio of the transformer when shifting a phase. In particular, the combined phase-shifter and three-phase-transformer structure and the energy conversion unit are added to a conventional uninterruptible power supply for remodeling the conventional uninterruptible power supply. Further, the present invention relates to a replacement system of a distribution transformer and a low-voltage power line without outage, which can be widespread at low costs through reconstruction of the system with a conventional mobile transformer alone.

2. Description of the Related Art

The present invention relates to an uninterruptible power supply and an uninterruptible replacement method on a 22.9 KV distribution-line for replacing a distribution transformer installed on the distribution-line without outage when there is a need for replacement of the transformer due to new extension, overload, and deterioration thereof.

As conventional methods for replacing the distribution transformer, a method of replacing the distribution transformer in a state that a transformer primary bypass cable and a transformer secondary bypass cable are each connected via a mobile transformer, and a method of replacing the transformer in a state that only the transformer secondary bypass cable is connected via a phase shifter are employed.

FIGS. 1a and 1b are an internal configuration and a shop drawing of a conventional uninterruptible power supply using a mobile transformer (hereinafter, like numerals indicate like components).

In FIG. 1a, the uninterruptible power supply using the mobile transformer includes a transformer primary bypass switch 31, a three-phase transformer 32, and a transformer secondary bypass switch 33.

Referring to FIG. 1b, a transformer primary bypass cable 24 and a transformer secondary bypass cable 21 are used to replace a distribution transformer 3′. During replacement, with the bypass cables respectively connected to the primary and secondary sides of a target transformer, load current is bypassed and a section switch 2 is switched-off to replace the transformer 3′.

However, the uninterruptible power supply using the mobile transformer 32 has the following problems: a sheath of the cable can be damaged during operation because a 22.9 KV outdoor cross-linked (OC) wire should be stripped before connecting the transformer primary bypass cable 24, it is impossible to replace a single-phase transformer having a large capacity of 150 kVA since the 300 kVA three-phase transformer is installed in the uninterruptible power supply, and a high-voltage power operating process of bypassing the primary and secondary sides of the transformer is complicated and entails high costs.

FIGS. 2a to 2c are an internal configuration and a shop drawing of a conventional uninterruptible power supply using a phase shifter.

In FIG. 2a, the uninterruptible power supply includes a phase shifter 50, a phase-shifting bypass switch 25, an automatic power-factor corrector 53, a single-phase transformer 60, and a low-voltage power line bypass switch 26.

Referring to FIG. 2b, to overcome the aforementioned problems shown in FIGS. 1a and 1b, the present inventors filed Korean Patent Application No. 10-2001-0046088, entitled “low-voltage phase shifter bypass connection device without power failure,” in which only the transformer secondary bypass cable 21 is connected to an extra-high voltage line without connecting the transformer primary bypass cable 24 thereto so that the distribution transformer can be replaced at a low voltage without outage, thereby solving the conventional inconvenience of bypassing the primary and secondary extra-high voltage lines.

Thus, this phase-shift uninterruptible power supply 40 provides effects of simplifying operation and reducing costs since connection of only the transformer secondary bypass cable 21 is needed. In this case, however, the existing two transformers 3 must sustain the load of the transformer 3′ to be replaced. Thus, if the load of the transformer 3′ exceeds the utilization ratio of the transformers 3, it is difficult to replace the transformer 3′.

Referring to FIG. 2c, if such a phase-shifting process is unavailable due to lack of a utilization ratio of a pole transformer, the transformer must be replaced after connecting the transformer with the transformer primary bypass cable 24 and the transformer secondary bypass cable 21. In this manner, a large-capacity transformer includes the 150 kVA single-phase transformer 60 therein and is thus replaceable, but there are problems in that the transformers must be sequentially replaced one by one and the three-phase transformers cannot be simultaneously replaced.

Further, the uninterruptible power supply using the mobile transformer must include three 150 kVA single-phase transformers or a 450 kVA three-phase transformer to replace the large-capacity transformer. However, an increase in capacity of the transformer results in an increase in size of an uninterruptible replacement vehicle, causing inconvenience in movement of the vehicle in a narrow area or the like.

Particularly, most companies possess a high-voltage and uninterruptible mobile transformer distributed initially. Accordingly, if the company wants to expand the uninterruptible replacement method, i.e., the phase-shift process that has a simple operating process and can reduce operating costs, it is necessary to additionally purchase a phase shifter (80 to 120 million Korean won), causing financial difficulty.

According to an embodiment of the present invention, a combined phase-shifter and three-phase-transformer 82 can be used as not only a three-phase transformer for transforming a three-phase high voltage into a low voltage when a phase-shift switch 85 is open, but also a phase shifter 50 for shifting a phase when the phase-shift switch 85 is closed. Conventionally, since an uninterruptible transformer device 30 includes three 100 kVA single-phase transformers or a single 300 kVA three-phase transformer, it is difficult to replace a large capacity 150 kVA transformer, and it is necessary to replace the 100 kVA single-phase transformers with a 150 kVA single-phase transformer or to replace the 300 kVA three-phase transformer with a 450 kVA three-phase transformer in order to replace the large capacity transformer. However, since an increase in capacity of the transformer results in an increase in size of the uninterruptible power supply, there is a problem in that the uninterruptible operation cannot be performed in an alleyway or other narrow areas. Such problems will be solved as follows.

### SUMMARY OF THE INVENTION

The present invention is conceived to solve the problems of the conventional techniques as described above, and an aspect of the present invention is to provide a replacement system of a distribution transformer and a low-voltage power line without outage, which can complement shortcomings of the conventional uninterruptible power supply and the conventional phase-shift uninterruptible power supply, in particular, which can use an energy converter to replace the large-capacity 150 kVA transformer with three embedded 100 kVA-transformers or an embedded 300 kVA-transformer of the uninterruptible power supply, and which can optimally adjust a utilization ratio of the existing two transformers burdened with the load of the transformer to be replaced when shifting the phase.

In accordance with an aspect of the present invention, a replacement system of a distribution transformer and a low-voltage power line in a distribution-line uninterruptible power supply including a transformer primary bypass cable, a transformer secondary bypass cable, and a low-voltage power line bypass cable, wherein the distribution-line uninterruptible power supply further includes a combined phase-shifter and three-phase transformer, a transformer primary bypass switch, a transformer secondary bypass switch, a phase-based power adjuster, an energy converter, and a three-phase AC/DC converter.

The combined phase-shifter and three phase transformer may be used as a three-phase transformer to convert a three-phase high voltage into a low voltage if a phase-shift switch is open, and may be used as a phase shifter to shift a phase if the phase-shift switch is closed.

The AC/DC converter may receive single-phase power from a transformer not to be replaced among three-phase power in a secondary Δ wiring of the combined phase-shifter and three-phase transformer through phase-based power adjusting switches and converts the single-phase power into DC voltage, and the energy converter may convert the DC power into AC power again to supply the AC power to a transformer to be replaced, via the phase-based power adjusting switches.

The energy converter may adjust a current amplitude and a phase angle of an inverter in the form of a current-type single phase inverter according to a load current of the transformer to be replaced, so that a utilization ratio of the transformer not to be replaced and a neutral-line current can be adjusted.

When replacing a c-phase transformer among a-, b- and c-phase transformers, the energy converter may adjust the current amplitude and the phase angle by adjusting a load current of a c-phase to have a phase angle more delayed than a voltage Vc in a manner of decreasing the utilization ratio of the a-phase transformer, and extending a replaceable range of the transformer at a low voltage by adjusting the load current of the c-phase to have a phase angle more advanced than the voltage Vc to reduce the utilization ratio of the b-phase transformer, so that load-current energy of the b-phase transformer is converted toward the b-phase transformer.

In accordance with another aspect of the present invention, there is provided a replacement system of a distribution transformer and a low-voltage power line in a distribution-line uninterruptible power supply comprising a transformer primary bypass cable, a transformer secondary bypass cable, and a low-voltage power line bypass cable, wherein the replacement system comprises a combined phase-shifter and three-phase transformer, a transformer primary bypass switch, a transformer secondary bypass switch, and a manual energy adjuster.

The manual energy adjuster may comprise energy adjusting banks, and each of the energy adjusting banks may comprise a magnet, an LC element, and a phase-shift switch.

The manual energy adjuster may extend a replaceable range of the transformer by adjusting a phase angle of a load current at a side of the transformer to be replaced through the LC element to adjust a utilization ratio of a transformer not to be replaced.

If a c-phase transformer is replaced among a-, b- and c-phase transformers, a utilization ratio of the b-phase transformer may be decreased by a process of introducing a transformer utilization ratio adjusting switch of an introduction switch when replacing the c-phase transformer, followed by sequentially adjusting capacitors to convert energy of a b-phase load for the a-phase transformer, a utilization ratio of the a-phase transformer may be decreased by a process of introducing a transformer utilization ratio adjusting switch of the introduction switch when replacing the c-phase transformer, followed by sequentially adjusting reactors to convert energy of an a-phase load for the b-phase transformer, and a neutral-line current may be adjusted by introducing a transformer utilization ratio adjusting switch of the introduction switch when replacing the c-phase transformer, followed by sequentially adjusting capacitors to adjust the neutral-line current and the utilization ratio of a pole transformer.

### BRIEF DESCRIPTION OF THE DRAWINGS

The above and other aspects, features and advantages of the present invention will become apparent from the following description of exemplary embodiments given in conjunction with the accompanying drawings, in which:

FIGS. 1a and 1b are an internal configuration and a shop drawing of a conventional uninterruptible power supply using a mobile transformer,

FIGS. 2a to 2c are an internal configuration and a shop drawing of a conventional uninterruptible power supply using a phase shifter,

FIG. 3 is a diagram of a distribution-line uninterruptible power supply according to an embodiment of the present invention,

FIGS. 4a to 4e are internal circuit diagrams of the distribution-line uninterruptible power supply according to the embodiment of the present invention,

FIGS. 5a to 5f are shop drawings of operation using the distribution-line uninterruptible power supply according to the embodiment of the present invention, and

FIGS. 6a to 6d are flowcharts of the operation using the distribution-line interruptible power supply according to the embodiment of the present invention.

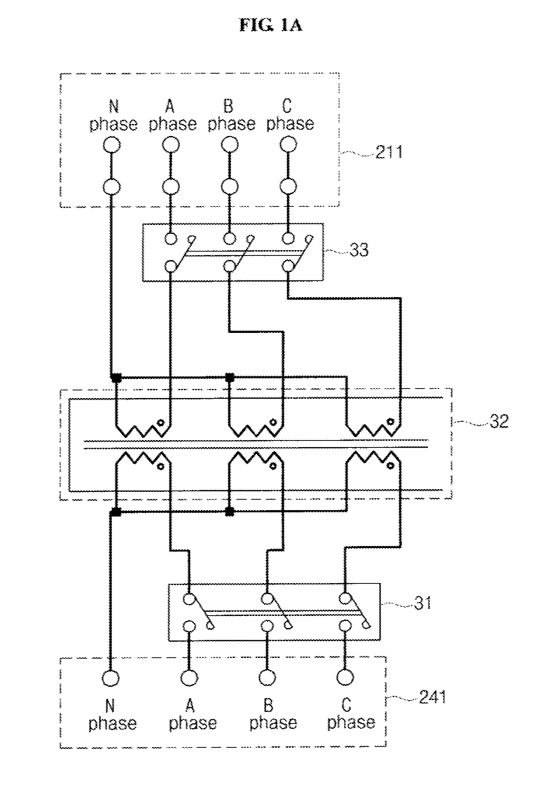

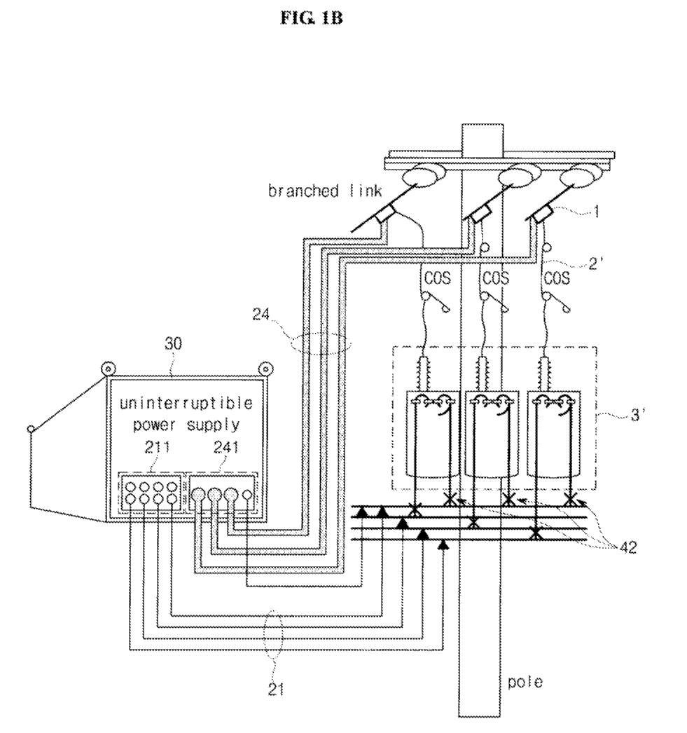

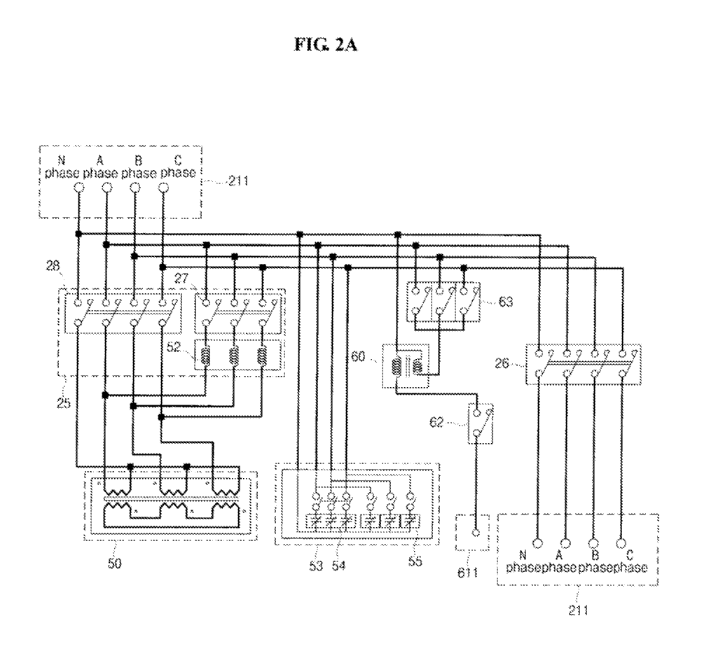

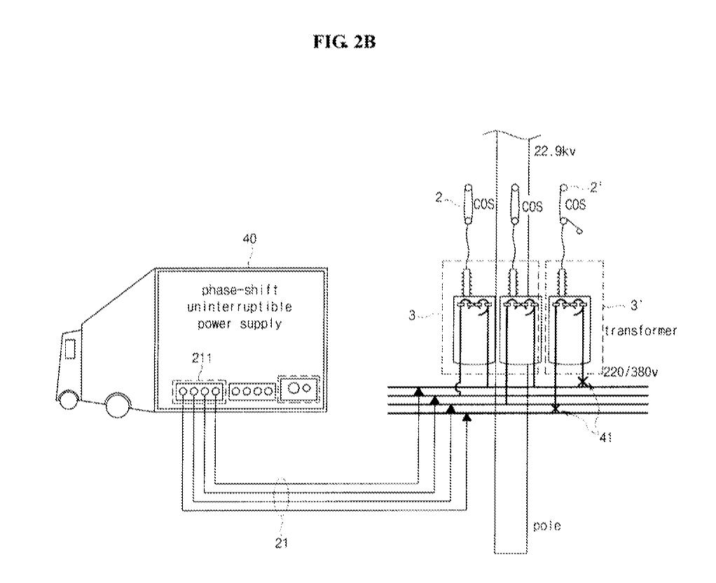

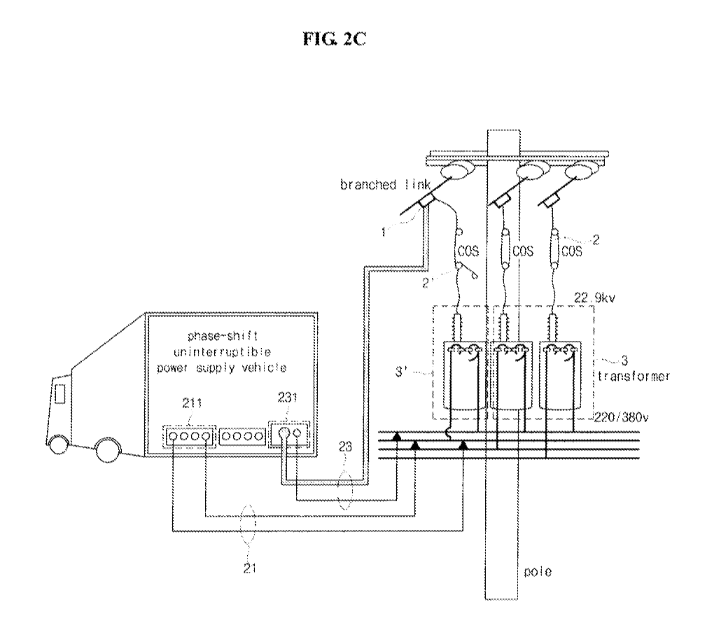

### DETAILED DESCRIPTION OF THE INVENTION

Exemplary embodiments of the present invention will be described in detail with reference to the accompanying drawings (hereinafter, like numerals refer to like elements throughout the drawings).

The present invention is characterized in that an energy converter 96 is used to adjust a utilization ratio according to phases, and in that a combined phase-shifter and three-phase transformer 82 has an integrated structure.

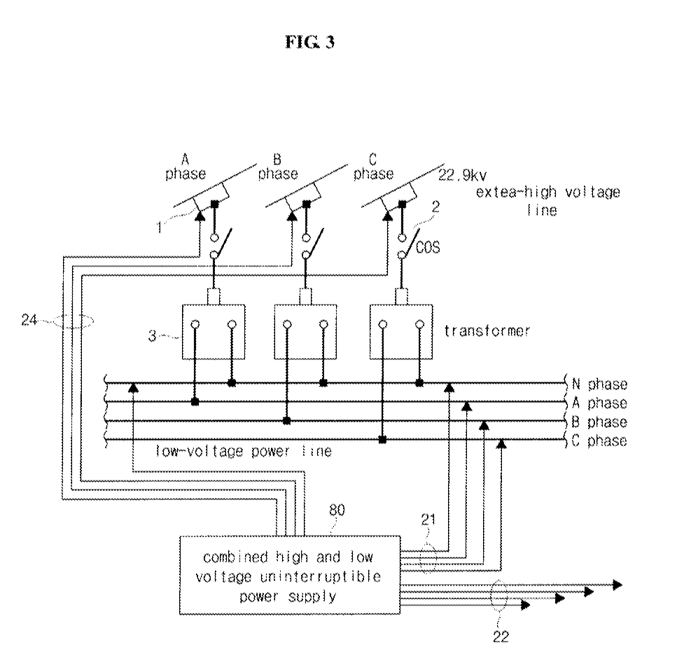

FIG. 3 is a diagram of a distribution-line uninterruptible power supply according to one embodiment of the present invention.

Referring to FIG. 3, a distribution-line uninterruptible power supply 80 includes a transformer primary bypass cable 24, a transformer secondary bypass cable 21, and a low-voltage power line bypass cable 22.

The distribution-line uninterruptible power supply 80 is generally operated by three operation processes as follows: a transformer process employing the transformer primary bypass cable 24 and the transformer secondary bypass cable 21, a phase-shifting process employing the transformer secondary bypass cable 21, and a line bypassing process employing the low-voltage power line bypass cable 22.

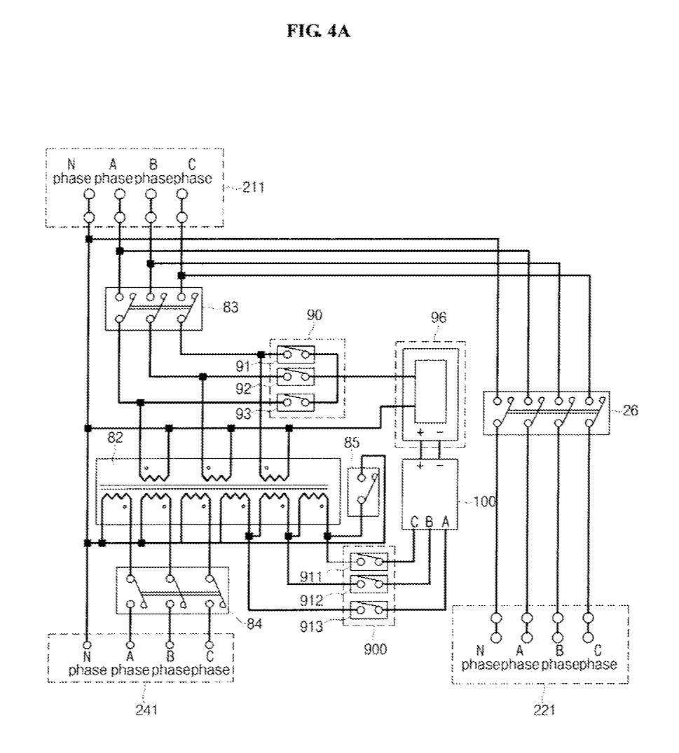

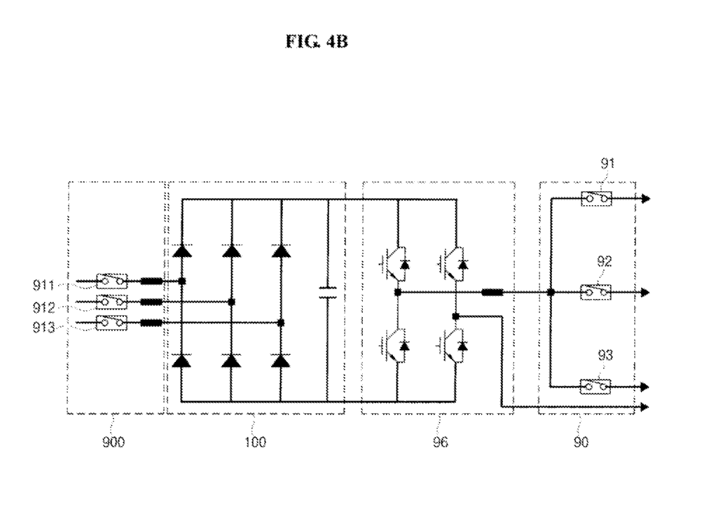

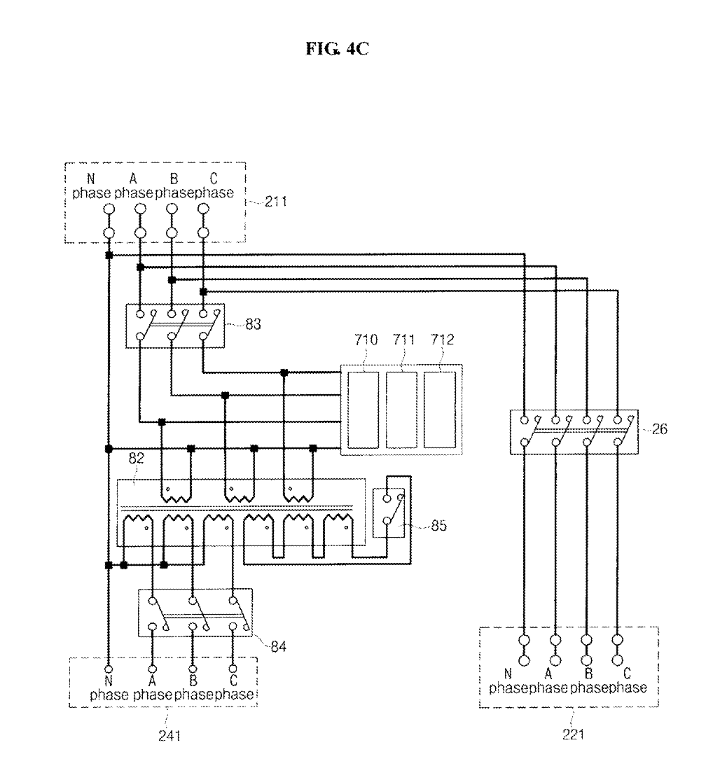

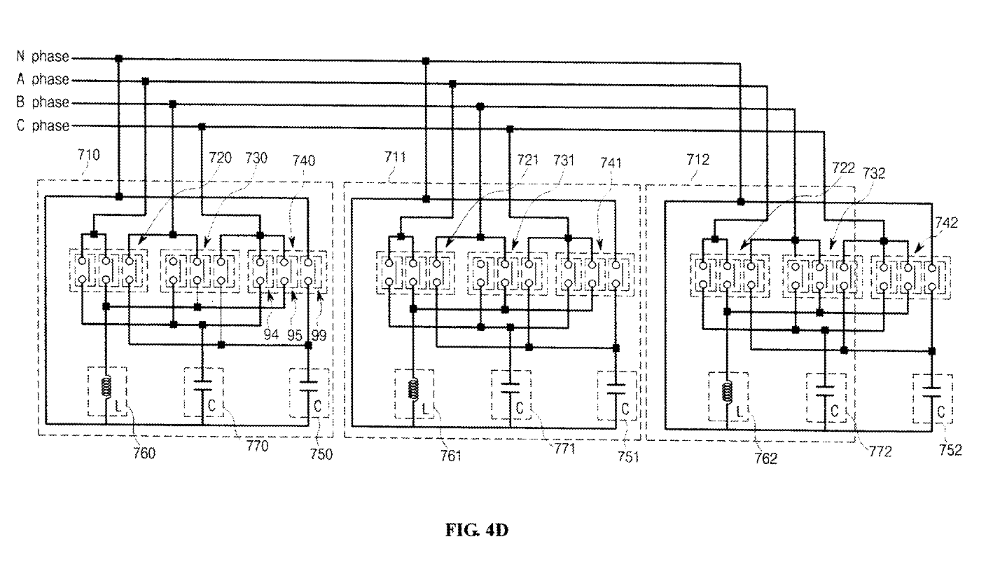

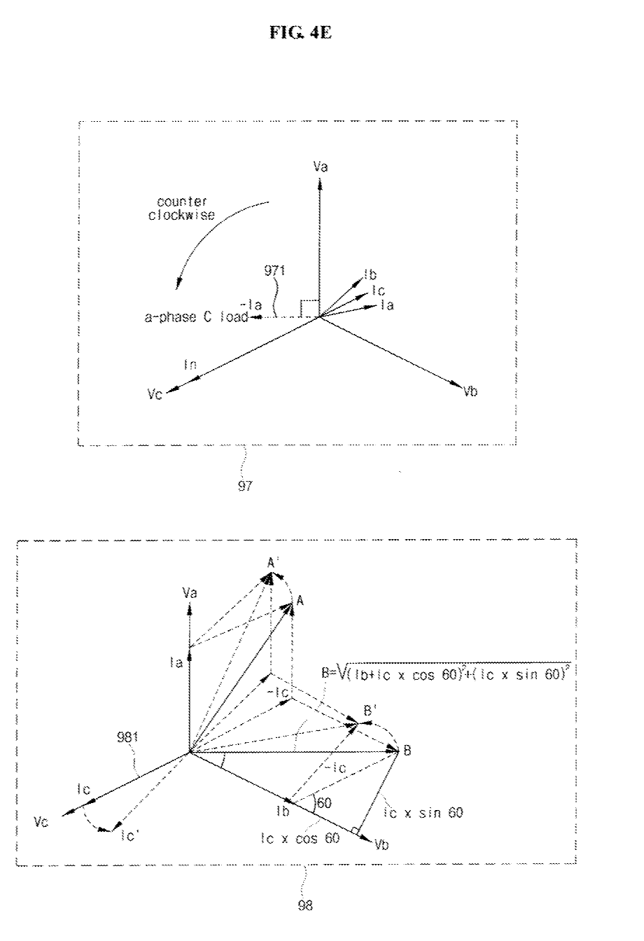

FIGS. 4a to 4e are internal circuit diagrams of the distribution-line uninterruptible power supply according to the embodiment of the present invention.

Referring to FIG. 4a, the distribution-line uninterruptible power supply 80 includes a combined phase-shifter and three-phase transformer 82, a transformer primary bypass switch 84, a transformer secondary bypass switch 83, phase-based power adjusters 90 and 900, the energy converter 96, and an AC/DC converter 100.

The combined phase-shifter and three-phase transformer 82 is employed not only as the conventional uninterruptible transformer device 30 when the phase-shift switch 85 is open, but also as the conventional phase-shift uninterruptible power supply 30 when the phase-shift switch 85 is closed. The AC/DC converter 100 receives single-phase power from the transformer not to be replaced among the three-phase power in a secondary Δ wiring of the combined phase-shifter and three-phase transformer 82 through phase-based power adjusting switches 911, 921 and 931, and converts the single-phase power into DC voltage. The converted DC voltage is input to the energy converter 96 where the DC power is converted back into AC power, which is in turn supplied to the transformer to be replaced through the phase-based power adjusting switches.

Referring to FIG. 4b, the phase-based power adjusters 90 and 900 includes the phase-based power adjusting switches 91, 92, 93, 911, 921 and 931.

Since the conventional uninterruptible power supply includes three single-phase 100 kVA transformers or a single three-phase 300 kVA transformer therein, it is difficult to replace the large-capacity 150 kVA transformer. To replace the large-capacity transformer, the single-phase 100 kVA transformer must be replaced with a single-phase 150 kVA transformer, or the three-phase 300 kVA transformer of must be replaced with a three-phase 450 kVA transformer. However, an increase in capacity of the transformer results in an increase in size of the uninterruptible power supply, causing inconvenience in movement of the uninterruptible power supply in a narrow area or the like, so that uninterruptible power replacement becomes difficult with the conventional uninterruptible power supply in an alleyway or other narrow areas.

Thus, with an energy conversion process according to one embodiment, the capacity of a distribution transformer to be replaced can be extended to one and half times the existing transformer. In particular, when the transformer is replaced by the phase-shift uninterruptible replacement process that uses a low voltage, the other two among three transformers must be burdened with the three-phase power. The energy conversion process allows the utilization ratio of the transformer to be adjusted according to the phases and has an advantage of extending the replaceable range at a low voltage without outage.

TABLE 1
Process of adjusting utilization ratio according to the present invention when
replacing transformer by the phase-shift process without outage

| Sorts | Phases | A | b | c | Comparison |
|---|---|---|---|---|---|
| Capacity | | 75.0 [kVA] | 50.0 [kVA] | 50.0 [kVA] | |
| Utilization ratio | | 60% | 80% | 60% | |
| Conventional | Capacity | 73.6 [kVA] | Replacement of | 69.3 [kVA] | Not |
| Method | Utilization ratio | 98.2% | b-phase | 138.6% | Replaceable |
| | | | Transformer | | |
| Inventive | Capacity | 83.6 [kVA] | Replacement of | 59.3 [kVA] | Replaceable |
| Method | Utilization ratio | 111.55 | b-phase | 118.6% | Phase shift |
| | | | Transformer | | from a to c by |
| | | | | | 10 [kVA] |

For example, when the b-phase transformer is replaced by the phase-shift uninterruptible replacement process under the condition that the utilization ratios of the transformer are 60%, 80% and 60% with regard to capacities of 75 kVA, 50 kVA and 50 kVA, respectively, the utilization ratio of the c-phase transformer exceeds a reference utilization ratio of 130%. Therefore, it is impossible to replace the c-phase transformer. In this case, the transformer primary bypass cable 24 and the transformer secondary bypass cable 21 are individually connected to replace the c-phase transformer by the uninterruptible replacement process at a high voltage.

On the other hand, according to one embodiment of the present invention, the energy converter 96 adjusts a phase angle of an inverter secondary current to thereby energy-convert the load (about 10 kVA) applied to the c-phase transformer into the load (about 10 kVA) of the a-phase transformer. Thus, the utilization ratio of the c-phase transformer is reduced from conventional 138.6% to 118.6%, so that the transformer can be replaced at a low voltage without outage.

FIG. 4c shows the distribution-line uninterruptible power supply according to the embodiment of the present invention, which employs a manual energy adjuster 700 including inexpensive LC elements, like that of FIG. 4a. Referring to FIG. 4c, the distribution-line uninterruptible power supply includes the combined phase-shifter and three-phase transformer 82, a transformer primary bypass switch 84, a transformer secondary bypass switch 83, and the manual energy adjuster 700.

Referring to FIG. 4d, the manual energy adjuster 700 includes energy adjusting banks 710, 711 and 712. The circuit of the energy adjusting bank 710 includes three magnets 720, 730 and 740, transformer utilization ratio adjusting switches 94, 95 and 99, and LC elements 750, 760 and 770. The manual energy adjuster 700 operates when the phase-shift switch 85 (see FIG. 4c) is closed. Since two transformers must be burdened with the load applied to three transformers when shifting the phase, the LC elements adjust the phase angles according to the phases, thereby adjusting the utilization ratio of the transformer.

FIG. 4e shows vectors of voltages and currents according to phases in the phase shifter and the pole transformer when replacing the c-phase transformer among three-phase transformers. When the c-phase transformer is replaced among the a-, b- and c-phase transformers in the manual energy adjuster 700, the amplitudes of the a-, b- and c-phases are similar to each other as shown in a current vector diagram 97 of the phase shifter, currents Ia, Ib and Ic are generated, and a neutral-line current is generated by about 200˜300% of the phase current in a direction opposite to a voltage Vc. Here, with respect to a counterclockwise voltage, the a-phase is delayed by 60 degrees, but the b-phase is advanced by 60 degrees. At this time, the amplitude −Ia of a capacitor current 971 is adjusted to decrease the amplitude of the neutral-line current, thereby adjusting the neutral-line current.

To adjust the utilization ratios of the a- and b-phase pole transformers when replacing the c-phase transformer, the transformer utilization ratio adjusting switch 94 of an introduced switch 740 is closed to apply the power to a capacitor 770, as shown in a current vector diagram 97 of the phase shifter, thereby generating a capacitor current advanced by 90 degrees with respect to the c-phase voltage. Therefore, the utilization ratio of the b-phase transformer decreases from B to B′, while the utilization ratio of the a-phase increases from A to A′. Further, when the transformer utilization ratio adjusting switch 95 is closed, the power is applied to a reactor 760, thereby generating a reactor current delayed by 90 degrees with respect to the c-phase voltage. At this time, the utilization ratio of the a-phase decreases, while the utilization ratio of the b-phase increases.

Accordingly, if a load current 981 Ic leads a voltage Vc when replacing the c-phase transformer, the utilization ratio of the a-phase transformer increases but that of the b-phase transformer decreases. On the other hand, if the reactor load is increased to the c-phase and the load current 981 Ic follows the voltage Vc, the utilization ratio of the b-phase transformer increases but that of the a-phase transformer decreases.

TABLE 2
Process of adjusting energy manually

| | | | | | | | | |
|---|---|---|---|---|---|---|---|---|
| One time | 720, 730, | ON | OFF | ON | OFF | ON | OFF | ON |
| | 740 | | | | | | | |
| Two times | 721, 731, | OFF | ON | ON | OFF | OFF | ON | ON |
| | 741 | | | | | | | |
| Four times | 722, 732, | OFF | OFF | OFF | ON | ON | ON | ON |
| | 742 | | | | | | | |

| | | | | | | | |
|---|---|---|---|---|---|---|---|
| Preset magnification | 1 | 2 | 3 | 4 | 5 | 6 | 7 |
| value | | | | | | | |
| Reactor capacity | 5 | 10 | 15 | 20 | 25 | 30 | 35 |
| (kVar) | | | | | | | |
| Capacitor capacity | 5 | 10 | 15 | 20 | 25 | 30 | 35 |
| (kVar) | | | | | | | |

To increase the utilization ratio and decrease the neutral-line current when replacing the transformer through the phase shifter, the manual energy adjuster 700 includes only the LC elements without the energy converter 96 of the inverter as described above. Referring to Table 2, the process of adjusting ineffective power includes seven steps of adjusting the ineffective power according to the amplitude of a load current through ON/OFF control based on combination of one-time switches 720, 730 and 740, two-time switches 721, 731 and 741, and four-time switches 722, 732 and 742.

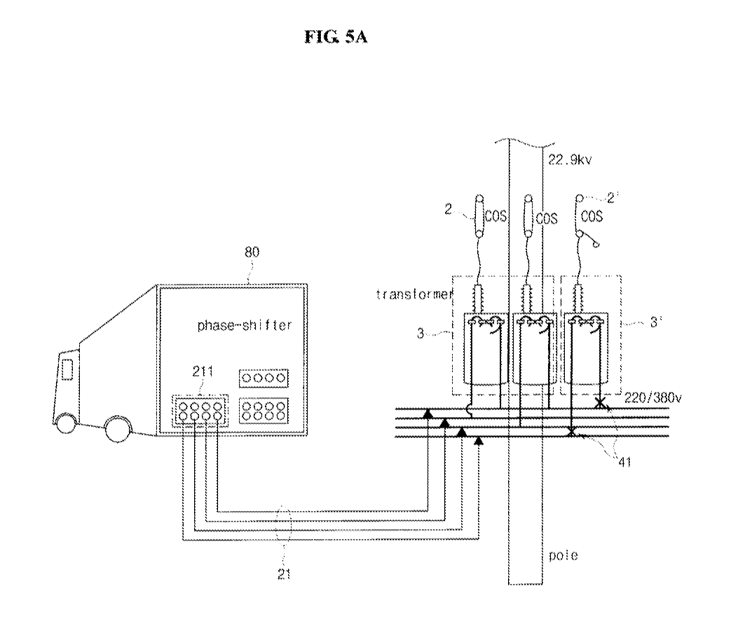

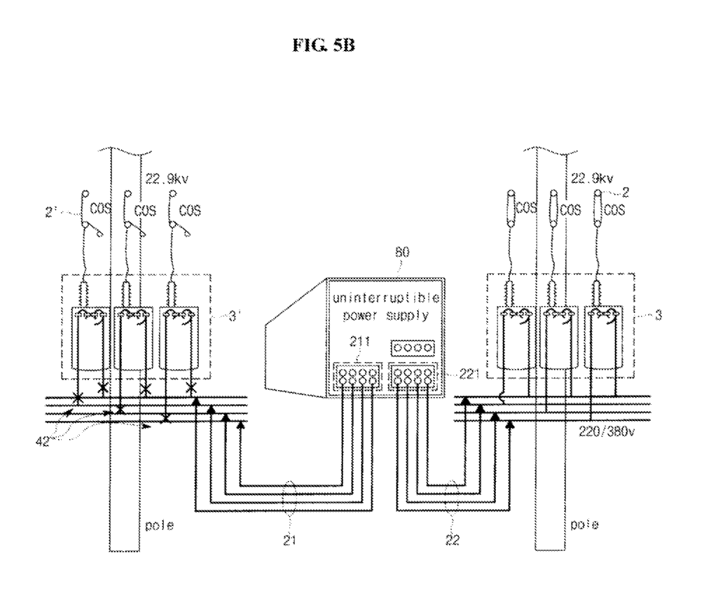

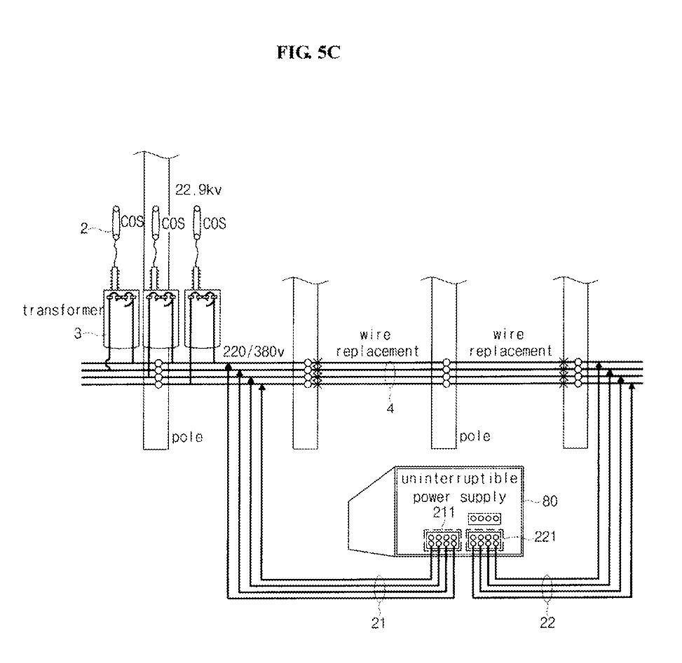

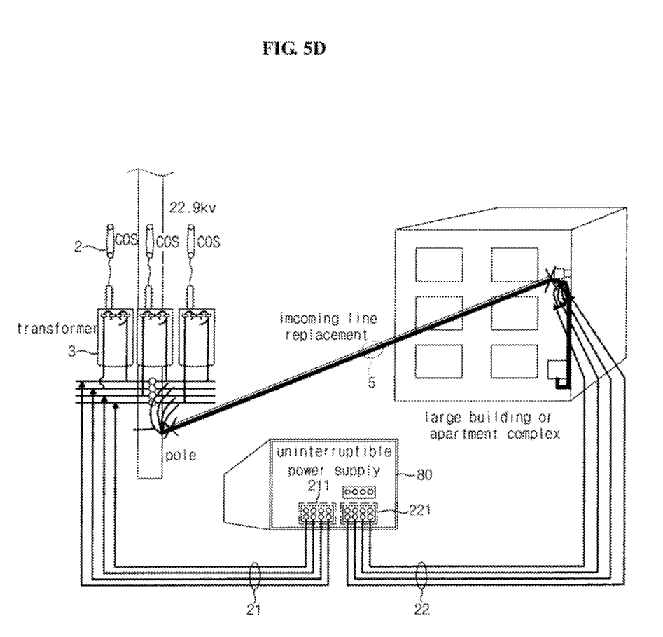

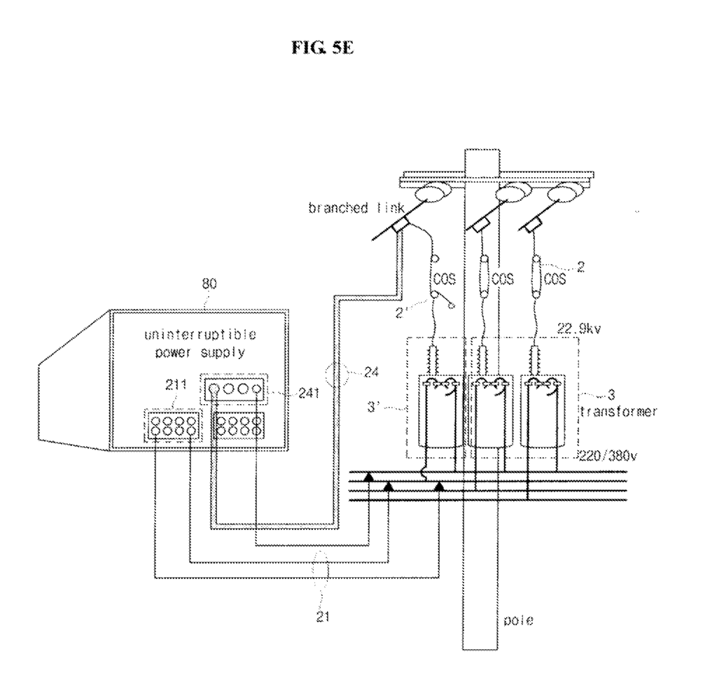

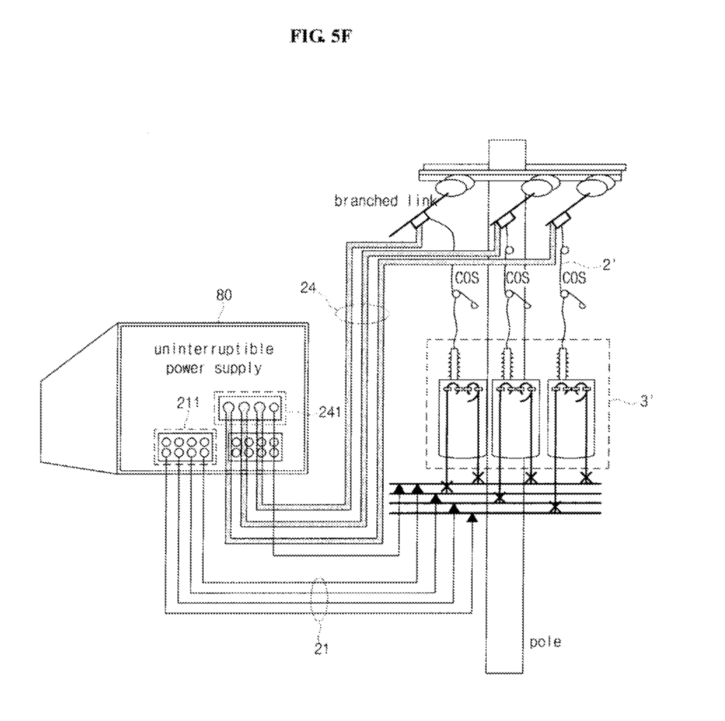

FIGS. 5a to 5f are shop drawings of operation using the distribution-line uninterruptible power supply according to the embodiment of the present invention.

FIG. 5a shows an uninterruptible replacement process using a low voltage, which replaces the distribution transformer 3′ by connecting the transformer secondary bypass cable 21 to the distribution-line depending on the phase-shift uninterruptible replacement process.

This process employs a principle that power from two transformers among three transformers is phase-shifted in the distribution-line uninterruptible power supply 80 when a third transformer is replaced, so that three-phase power can be supplied to a load side. In this embodiment, the energy converter 96 and the phase-based power adjuster 90 and 900 are used to efficiently adjust the utilization ratios of the transformers.

FIG. 5b shows an uninterruptible replacement process in which the three-phase transformers are replaced simultaneously by introducing the low-voltage power line bypass switch 26 (see FIG. 4c) after phase detection through the distribution-line uninterruptible power supply 80 that connects the low-voltage power line bypass cable 22 with the secondary side of a neighbor transformer 3 and connects the transformer secondary bypass cable 21 with the secondary side of the transformer 3′ to be replaced.

FIGS. 5c and 5d show uninterruptible replacement processes that replace low-voltage power lines 4 and 5 using the distribution-line uninterruptible power supply 80 without outage, in which the low-voltage power lines 4 and 5 to be replaced are bypassed by the transformer secondary bypass cable 21 and the low-voltage power line bypass cable 22, and are then replaced without outage.

Referring to FIG. 5e, if it is impossible to replace the large-capacity transformer without outage due to lack of the utilization ratio, an improper area for replacement by the phase-shift process, etc., only a transformer corresponding to the high-voltage uninterruptible replacement process can be easily replaced by individually connecting the transformer primary bypass cable 24 and the transformer secondary bypass cable 21

Referring to FIG. 5f, if the transformer to be replaced has a capacity of 150 kVA or more, it cannot be replaced using the existing mobile transformer device. Further, if the phase-shift uninterruptible replacement process is used to replace this transformer, it is necessary to sequentially replace the transformers one by one. Particularly, it is impossible to replace an individual three-phase integrated pole transformer with a single-phase one. Accordingly, the three-phase comprehensive uninterruptible replacement method is used like the method according to an embodiment of the present invention.

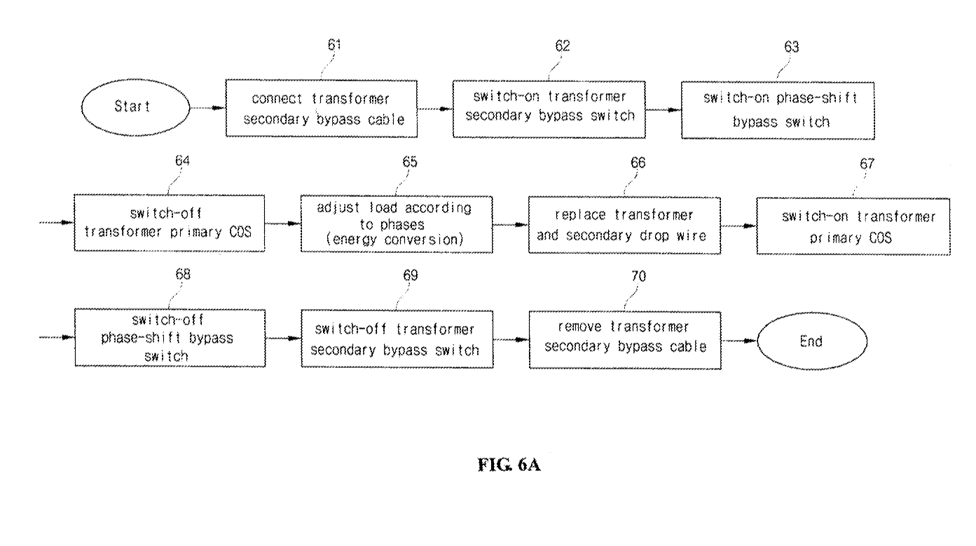

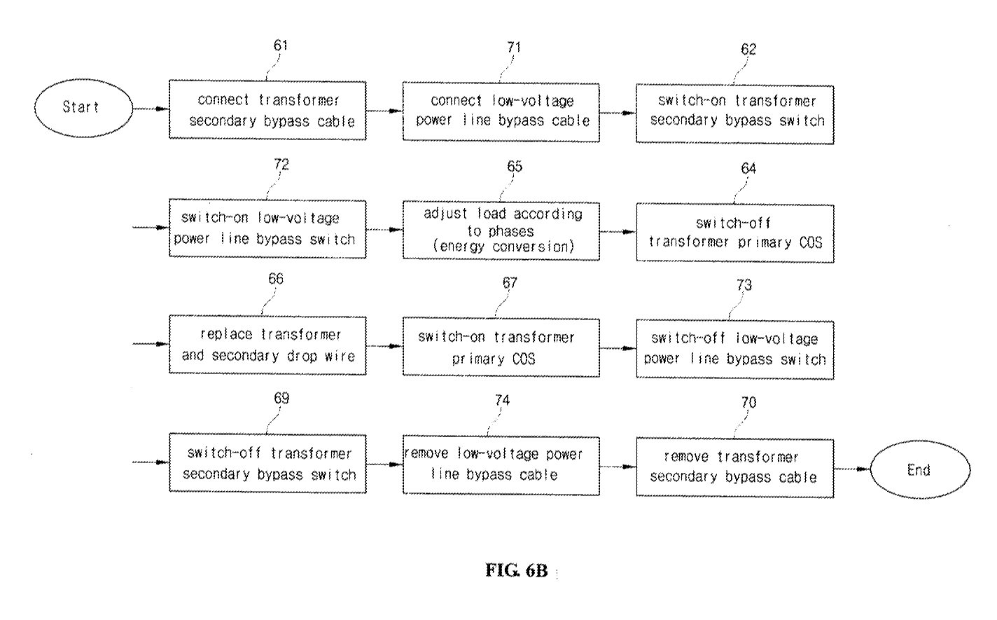

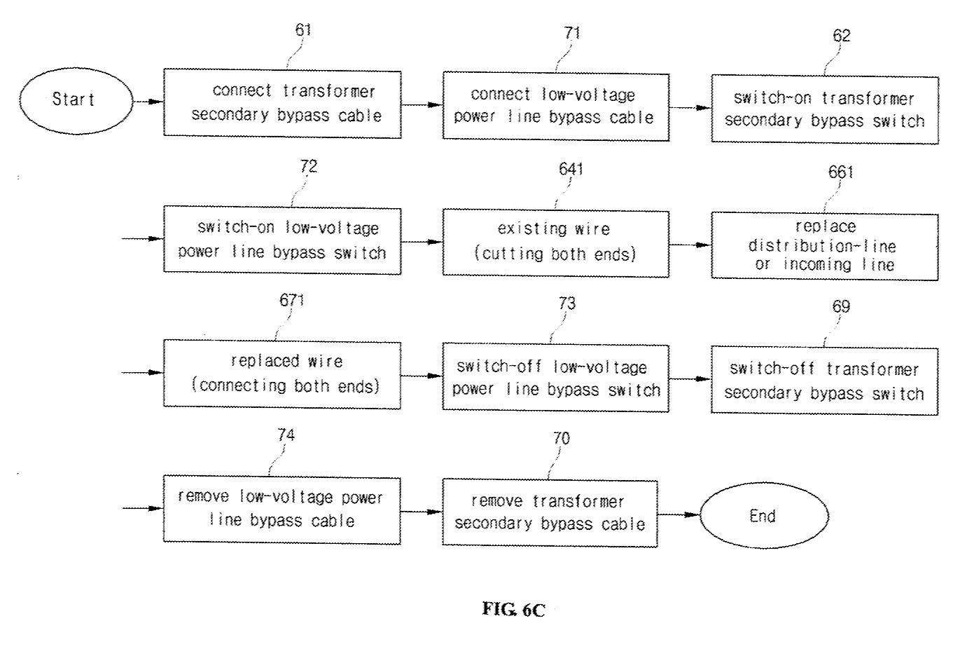

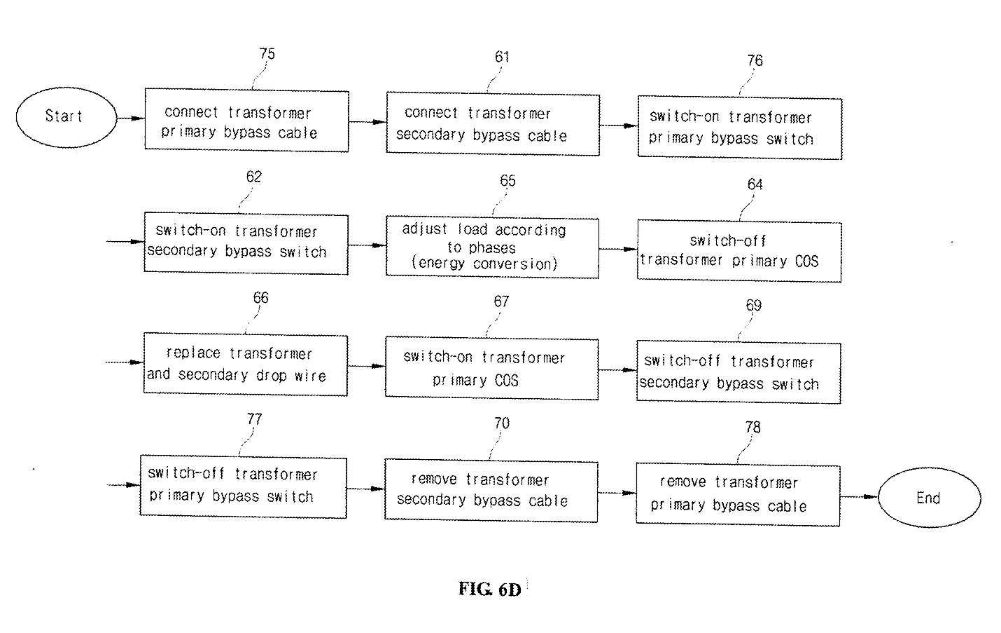

FIGS. 6a to 6d are flowcharts of operation using the distribution-line interruptible power supply 80 according to the embodiment of the present invention. The distribution-line interruptible power supply 80 can be used for a phase-shift uninterruptible replacement process, a mobile transformer uninterruptible replacement process, and a low-voltage power line bypass process.

FIG. 6a shows a flowchart of the phase-shift uninterruptible replacement process, a shop drawing of which is shown in FIG. 5a. The sequence of operations is as follows: start—Operation 61—Operation 62—Operation 63—Operation 64—Operation 65—Operation 66—Operation 67—Operation 68—Operation 69—Operation 70—end. In more detail, at Operation 61, the distribution-line uninterruptible power supply 80 connects the transformer secondary bypass cable 21 to the secondary side of the distribution transformer 3. At Operations 62 and 63, the transformer secondary bypass switch 83 and the phase-shift switch 85 are introduced. At Operation 64, a primary section switch 2′ of a transformer to be replaced is switched-off. At Operation 65, the energy converter 96 adjusts the utilization ratio of the transformer. At Operation 66, the transformer and a secondary drop wire 41 are replaced. At Operation 67, the primary section switch 2′ is introduced. At Operations 68 and 69, the phase-shift switch 85 is switched-off and the transformer secondary bypass switch 83 is switched-off. At Operation 70, the transformer secondary bypass cable 21 is removed to thereby complete the process.

FIG. 6b shows a flowchart of another low-voltage power line bypass uninterruptible replacement process. This process uses a neighbor transformer when replacing the transformer 3, which is equivalent to the shop drawing of FIG. 5a. Sequence of operations is as follows: start—Operation 61—Operation 71—Operation 62—Operation 72—Operation 65—Operation 64—Operation 66—Operation 67—Operation 73—Operation 69—Operation 74—Operation 70—end. In more detail, at Operation 61, the distribution-line uninterruptible power supply 80 connects the transformer secondary bypass cable 21 to the secondary side of the distribution transformer 3. At Operation 71, the low-voltage power line bypass cable 22 is connected to the secondary side of the neighbor transformer. At Operations 62 and 72, the transformer secondary bypass switch and the low-voltage power line bypass switch are introduced. At Operation 65, the energy converter 96 adjusts the utilization ratio of the transformer. At Operation 64, the primary section switch 2 is switched-off. At Operation 66, the transformer 3 and a drop wire 42 are replaced. At Operation 67, the primary section switch 2 is switched-on. At Operations 73 and 69, the low-voltage power line bypass switch 85 is switched-off, and then the transformer secondary bypass switch 83 is switched-off. At Operations 74 and 70, the low-voltage power line bypass cable 22 and the transformer secondary bypass cable 21 are removed to thereby complete the process.

FIG. 6c is a flowchart of the low-voltage power line bypass uninterruptible replacement process. This low-voltage power line bypass uninterruptible replacement process is a low voltage uninterruptible replacement process used when replacing a low-voltage power line 4 and an incoming line 5, and the shop drawing thereof is shown in FIGS. 5c and 5d. Sequence of operations is as follows: start—Operation 61—Operation 71—Operation 62—Operation 72—Operation 641—Operation 661—Operation 671—Operation 73—Operation 69—Operation 74—Operation 70—end.

At Operation 61, the distribution-line uninterruptible power supply 80 connects the transformer secondary bypass cable 21 to a start part of the low-voltage power line to be replaced. At Operation 71, the low-voltage power line bypass cable 22 is connected to an end part of the low-voltage power line to be replaced. At Operations 62 and 72, the transformer secondary bypass switch 83 and the low-voltage power line bypass switch 26 are introduced. At Operation 641, the start part and the end part of the low-voltage power line to be replaced are cut in the state that the line is bypassed. At Operation 661, the low-voltage power line or the incoming line are replaced. At Operation 671, the replaced low-voltage power line is normally connected to the start part and the end part. At Operation 73 and 69, the low-voltage power line bypass switch 26 is switched-off, and the transformer secondary bypass switch 83 is then switched-off. At Operations 74 and 70, the low-voltage power line bypass cable 22 and the transformer secondary bypass cable are removed to thereby complete the process.

FIG. 6d shows a flowchart of the mobile transformer uninterruptible replacement process. This low-voltage uninterruptible replacement process is implemented when it is impossible to replace the transformer 3 using the phase-shift uninterruptible replacement process or the neighbor transformer, and the shop drawing thereof is shown in FIGS. 5e and 5f.

Sequence of operations is as follows: start—Operation 75—Operation 61—Operation 76—Operation 62—Operation 65—Operation 64—Operation 66—Operation 67—Operation 69—Operation 77—Operation 70—Operation 78—end. In more detail, at Operation 75, the distribution-line uninterruptible power supply 80 connects the transformer primary bypass cable 24 to the primary sides of the distribution transformers 3 and 3′. At Operation 61, the transformer secondary bypass cable 21 is connected to the secondary side of the transformer 3 to be replaced. At Operations 76 and 62, the transformer primary bypass switch 84 and the transformer secondary bypass switch 83 are introduced. At Operation 65, the energy converter 96 adjusts the utilization ratio of the transformer. At Operation 64, the transformer primary section switch 21 is switched-off. At Operation 66, the transformer 3 and the drop wire 42 are replaced. At Operation 67, the transformer primary section switch 2 is switched-on. At Operations 69 and 77, the low-voltage power line bypass switch 26 is switched-off, and then the transformer secondary bypass switch 83 is switched-off. Then, at Operation 70 and 78 the low-voltage power line bypass cable 22 and the transformer secondary bypass cable 21 are removed to thereby complete the process.

As apparent from the above description, according to the present invention, the utilization ratio of the transformer is adjustable via the energy converter 96, so that the capacity of the replaceable distribution transformer can be extended to one and half times the capacity of the existing transformer.

In particular, when a single transformer among three transformers is replaced by the phase-shift uninterruptible replacement process that employs a low voltage in replacing the transformer, the other two must be burdened with the three-phase power. Thus, the energy conversion process according to the present invention allows the utilization ratio of the transformer to be adjusted according to the phases and provides an advantage of extending the replaceable range of the transformer at a low voltage without outage. Further, practical equipment may be secured at a low cost by replacing only the transformer in the existing uninterruptible power supply.

Although the present invention has been described with reference to the embodiments and the accompanying drawings, it will be apparent to those skilled in the art that the embodiments are given by way of illustration, and that various modifications and equivalent embodiments can be made without departing from the spirit and scope of the present invention, as set forth in the following claims.

What is claimed is:

1. A replacement system of a distribution transformer and a low-voltage power line in a distribution-line uninterruptible power supply comprising a transformer primary bypass cable, a transformer secondary bypass cable, and a low-voltage power line bypass cable,
wherein the distribution-line uninterruptible power supply further comprises a combined phase-shifter and three-phase transformer, a transformer primary bypass switch, a transformer secondary bypass switch, a phase-based power adjuster, an energy converter, and a three-phase AC/DC converter.

2. The replacement system according to claim 1, wherein the combined phase-shifter and three phase transformer is used as a three-phase transformer to convert a three-phase high voltage into a low voltage if a phase-shift switch is open, and is used as a phase shifter to shift a phase if the phase-shift switch is introduced.

3. The replacement system according to claim 2, wherein the AC/DC converter receives single-phase power from a transformer not to be replaced among three-phase power in a secondary Δ wiring of the combined phase-shifter and three-phase transformer through phase-based power adjusting switches and converts the single-phase power into DC voltage, and wherein the energy converter converts the DC power into AC power again to supply the AC power to a transformer to be replaced, via the phase-based power adjusting switches.

4. The replacement system according to claim 3, wherein the energy converter adjusts a current amplitude and a phase angle of an inverter in the form of a current-type single phase inverter according to a load current of the transformer to be replaced, so that a utilization ratio of the transformer not to be replaced and a neutral-line current can be adjusted.

5. The replacement system according to claim 4, wherein, when replacing a c-phase transformer among a-, b- and c-phase transformers, the energy converter adjusts the current amplitude and the phase angle by adjusting a load current of a c-phase to have a phase angle more delayed than a voltage Vc in a manner of decreasing the utilization ratio of the a-phase transformer, and extending a replaceable range of the transformer at a low voltage by adjusting the load current of the c-phase to have a phase angle more advanced than the voltage Vc to reduce the utilization ratio of the b-phase transformer, so that load-current energy of the b-phase transformer is converted toward the b-phase transformer.

6. A replacement system of a distribution transformer and a low-voltage power line in a distribution-line uninterruptible power supply comprising a transformer primary bypass cable, a transformer secondary bypass cable, and a low-voltage power line bypass cable, the replacement system comprising: a combined phase-shifter and three-phase transformer; a transformer primary bypass switch; a transformer secondary bypass switch; and a manual energy adjuster.

7. The replacement system according to claim 6, wherein the manual energy adjuster comprises energy adjusting banks, and each of the energy adjusting bank comprises a magnet, an LC element, and a phase-shift switch.

8. The replacement system according to claim 7, wherein the manual energy adjuster extends a replaceable range of the transformer by adjusting a phase angle of a load current at a side of a transformer to be replaced through the LC element, and adjusting a utilization ratio of a transformer not to be replaced.

9. The replacement system according to claim 7, wherein if a c-phase transformer is replaced among a-, b- and c-phase transformers,
a utilization ratio of the b-phase transformer is decreased by a process of introducing a transformer utilization ratio adjusting switch 94 of an introduction switch when replacing the c-phase transformer, followed by sequentially adjusting capacitors to convert energy of a b-phase load for the a-phase transformer;
a utilization ratio of the a-phase transformer is decreased by a process of introducing a transformer utilization ratio adjusting switch of the introduction switch when replacing the c-phase transformer, followed by sequentially adjusting reactors to convert energy of an a-phase load for the b-phase transformer; and
a neutral-line current is adjusted by introducing a transformer utilization ratio adjusting switch of the introduction switch when replacing the c-phase transformer, followed by sequentially adjusting capacitors to adjust the neutral-line current and the utilization ratio of a pole transformer.

10. A method of replacing a distribution transformer and a low-voltage power line via a phase-shift uninterruptible replacement process, comprising:
connecting a transformer secondary bypass cable with a secondary side of a distribution transformer in a distribution-line uninterruptible power supply;
introducing a transformer secondary bypass switch and a phase-shift switch,
switching-off a transformer primary section switch of a transformer to be replaced,
adjusting a load according to phases in an energy converter, and replacing the transformer and a secondary drop wire,
introducing the transformer primary section switch,
switching-off the phase-shift switch, followed by switching-off the transformer secondary bypass switch, and
removing the transformer secondary bypass cable.

11. A method of replacing a distribution transformer and a low-voltage power line by a low-voltage power line bypass uninterruptible replacement process, comprising:
connecting a transformer secondary bypass cable with a secondary side of a distribution transformer in a distribution-line uninterruptible power supply,
connecting a low-voltage power line bypass cable with a secondary side of a neighbor transformer,
introducing a transformer secondary bypass switch and a low-voltage power line bypass switch,
adjusting a load according to phases in an energy converter,
switching-off a transformer primary section switch,
replacing the distribution transformer and a drop wire,
switching-on the transformer primary section switch,
switching-off a low-voltage power line bypass switch, followed by switching-off the transformer secondary bypass switch, and
removing the low-voltage power line bypass cable and the transformer secondary bypass cable.

12. A method of replacing a distribution transformer and a low-voltage power line by a low-voltage power line bypass uninterruptible replacement process, comprising:
connecting a transformer secondary bypass cable with a start part of a low-voltage power line to be replaced in a distribution-line uninterruptible power supply,
connecting a low-voltage power line bypass cable with an end part of the low-voltage power line to be replaced,
introducing a transformer secondary bypass switch and a low-voltage power line bypass switch,
cutting the start and end parts of the low-voltage power line to be replaced in a state that the low-voltage power line is bypassed,
replacing the low-voltage power line or an incoming line, and connecting the start and end parts of the replaced low-voltage power line normally, and
removing the low-voltage power line bypass cable and the transformer secondary bypass cable.

13. A method of replacing a distribution transformer and a low-voltage power line by a mobile transformer uninterruptible replacement process, comprising:
connecting a transformer primary bypass cable with a primary side of a distribution transformer in a distribution-line uninterruptible power supply,
connecting a transformer secondary bypass cable with a secondary side of the transformer to be replaced,
introducing a transformer primary bypass switch and a transformer secondary bypass switch,
adjusting a load according to phases in an energy converter,
switching-off the transformer primary section switch,
replacing the transformer and a drop wire,
switching-on the transformer primary section switch,
switching-off the low-voltage power line bypass switch, followed by switching-off the transformer secondary bypass switch, and
removing a low-voltage power line bypass cable and the transformer secondary bypass cable.
